(19) United States
(12) Patent Application Publication
(10) Pub. No.: US 2007/0232750 A1
(43) Pub. Date: Oct. 4, 2007

(54) Adhesive for silicone rubber

(75) Inventors: Mitsuhiro Iwata, Annaka-shi (JP); Yoshifumi Harada, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/730,470

(22) Filed: Apr. 2, 2007

(30) Foreign Application Priority Data
Apr. 3, 2006 (JP) 2006-101551

(51) Int. Cl. C08L 83/04; B32B 5/16

(52) U.S. Cl. 524/588; 525/477; 525/478; 528/15; 528/31; 528/32; 428/403

(57) ABSTRACT

An adhesive comprising (A) an organopolysiloxane containing, on average, at least two silicon-bonded alkenyl groups in a molecule, (B) an organohydrogenpolysiloxane containing, on average, at least two SiH groups in a molecule, (C) a calcium carbonate powder surface treated with a paraffinic compound and having a specific surface area of up to 6 m²/g, and (D) a platinum group metal catalyst is fully adherent to silicone rubber and shelf stable.

### CROSS-REFERENCE TO RELATED APPLICATION

This non-provisional application claims priority under 35 U.S.C. §119(a) on Patent Application No. 2006-101551 filed in Japan on Apr. 3, 2006, the entire contents of which are hereby incorporated by reference.

This invention relates to an adhesive for silicone rubber, and more particularly, to an adhesive which effectively adheres to a silicone rubber obtained by curing an addition cure type silicone rubber composition (simply referred to as addition cured silicone rubber, hereinafter).

### BACKGROUND OF THE INVENTION

Because of excellent properties including water repellency, weatherability and heat resistance, silicone rubbers are used as coatings and film-formers on a variety of substrates. Silicone rubbers, however, suffer from poor adhesion. Under the circumstances, JP-A 61-278580 corresponding to U.S. Pat. No. 4,766,193 discloses an adhesive for silicone rubber comprising a polyorganosiloxane containing silicon-bonded alkenyl groups and silicon-bonded alkoxy or silanol groups, a condensation reaction catalyst, and an organic peroxide. Also, JP-A 62-90369 corresponding to U.S. Pat. No. 4,889,576 discloses a process comprising laminating silicone-coated fabric plies while sandwiching between the plies a silicone rubber adhesive of platinum group catalyst-containing addition cure type or organic peroxide-containing radical reaction cure type which is plastic at normal temperature, and successively or simultaneously pressure bonding and heat curing. In particular, the silicone rubber adhesive of platinum group catalyst-containing addition cure type described in JP-A 62-90369 suffers from a problem that it is not fully adherent to addition cured silicone rubber.

JP-A 2002-285130 corresponding to U.S. Pat. No. 6,811,650 discloses an addition cure type silicone rubber composition loaded with calcium carbonate powder, as an adhesive for silicone rubber. Particularly when the composition contains a light (or precipitated) calcium carbonate powder surface treated with only a surface treating agent such as a fatty acid or resin acid, the calcium carbonate powder can poison the platinum group metal catalyst, retarding or preventing the composition from curing after a lapse of time.

### DISCLOSURE OF THE INVENTION

An object of the invention is to provide an adhesive for addition cured silicone rubber, which effectively adheres to the silicone rubber and is shelf stable.

The inventors have found that an addition cure type silicone composition comprising a calcium carbonate powder having a certain specific surface area effectively adheres to silicone rubber, especially addition cured silicone rubber.

The invention provides an adhesive for silicone rubber comprising

(A) 100 parts by weight of an organopolysiloxane containing, on average, at least two silicon-bonded alkenyl groups in a molecule and having a viscosity of 0.05 to 1,000 Pa-s at 23° C.,

(B) an organohydrogenpolysiloxane containing, on average, at least two silicon-bonded hydrogen atoms in a molecule and having a viscosity of 0.001 to 100 Pa-s at 23° C., in such an amount that the molar ratio of silicon-bonded hydrogen atoms in component (B) to alkenyl groups in component (A) is from 0.01 to 20,

(C) 1 to 100 parts by weight of a calcium carbonate powder surface treated with a paraffinic compound and having a specific surface area of up to 6 m²/g, as measured by the air-permeability method, and

(D) an effective amount of a platinum group metal catalyst.

Typically, the calcium carbonate powder (C) is a heavy calcium carbonate powder having a specific surface area of up to 6 m²/g, as measured by the air-permeability method. The adhesive may further comprise (E) 1 to 100 parts by weight of a finely divided silica having a specific surface area of at least 50 m²/g, as measured by the nitrogen adsorption method. In a preferred embodiment, components (A) and (E) are previously heat mixed. The adhesive may further comprise a tackifier.

The adhesive is typically for use with a silicone rubber which is obtained by curing an addition cure type silicone rubber composition.

### BENEFITS OF THE INVENTION

The adhesive of the invention effectively adheres to silicone rubber, especially addition cured silicone rubber and has shelf stability.

### DESCRIPTION OF THE PREFERRED EMBODIMENT

Briefly stated, the adhesive for silicone rubber of the invention comprises (A) an alkenyl-containing organopolysiloxane, (B) an organohydrogenpolysiloxane, (C) a calcium carbonate powder surface treated with a paraffinic compound, and (D) a platinum group metal catalyst.

### Component A

Component (A) is a base polymer in the inventive adhesive. It is an organopolysiloxane containing, on average, at least two alkenyl groups each bonded to a silicon atom in a molecule, preferably at least 2 alkenyl groups, specifically 2 to about 50 alkenyl groups, more preferably 2 to about 20 alkenyl groups each bonded to a silicon atom in a molecule, and having a viscosity of 0.05 to 1,000 Pa-s at 23° C. It is noted that the viscosity as used herein is measured by a rotational viscometer.

The molecular structure of the organopolysiloxane (A) is not particularly limited and may be a linear, partially branched linear, branched, cyclic, or branched cyclic structure, for example. Preferred component (A) is a substantially linear organopolysiloxane and more specifically a linear diorganopolysiloxane in which the backbone consists essentially of repeating diorganosiloxane units and both ends of the molecular chain are capped with triorganosiloxy groups. Component (A) may be either a polymer composed of siloxane units of one type or a copolymer composed of siloxane units of two or more types. The position of silicon-bonded alkenyl group is not particularly limited. The alkenyl groups may be bonded to either one or both of the silicon atoms at the ends of the molecular chain and silicon atoms at non-end or intermediate positions of the molecular chain.

Component (A) generally has a viscosity of 0.05 to 1,000 Pa-s and preferably 0.1 to 500 Pa-s at 23° C. If the viscosity is too low, in some cases, the resulting adhesive may not have satisfactory physical properties and adhesion in the cured state. If the viscosity is too high, the resulting adhesive may become less flowable and difficult to work.

Exemplary of component (A) is an organopolysiloxane g the average compositional formula (1):

Rₘ¹Rₙ²SiO_{(4-m-n)/2} (1)

wherein R¹ is each independently a substituted or unsubstituted monovalent hydrocarbon group free of aliphatic unsaturation, R² is each independently an alkenyl group, m is usually a positive number of 0.7 to 2.2, preferably 1.8 to 2.1, more preferably 1.95 to 2.0, n is usually a positive number of 0.0001 to 0.2, preferably 0.0005 to 0.1, more preferably 0.01 to 0.05, m+n is usually a positive number of 0.8 to 2.3, preferably 1.9 to 2.2, more preferably 1.98 to 2.05, said organopolysiloxane containing at least two silicon-bonded alkenyl groups and having a viscosity of 0.05 to 1,000 Pa-s and preferably 0.1 to 500 Pa-s at 23° C.

R¹ stands for a substituted or unsubstituted monovalent hydrocarbon group free of aliphatic unsaturation, typically of 1 to 10 carbon atoms. Examples include alkyl groups such as methyl, ethyl, propyl, isopropyl, butyl, isobutyl, tert-butyl, hexyl, octyl and decyl; aryl groups such as phenyl, tolyl, xylyl and naphthyl; cycloalkyl groups such as cyclopentyl and cyclohexyl; atalkyl groups such as benzyl, 2-phenylethyl and 3-phenylpropyl; and substituted forms of the foregoing groups in which some or all hydrogen atoms bonded to carbon atoms are substituted by halogen atoms (e.g., chloro, bromo, iodo), cyano groups or the like, such as chloromethyl, 2-bromoethyl, 3,3,3-trifluoropropyl and cyanoethyl.

Of these groups, methyl, phenyl or a combination thereof is preferred because those organopolysiloxanes of formula (1) wherein R¹ is methyl, phenyl or a mixture thereof are easy to synthesize and chemically stable. Particularly when it is desired to use an organopolysiloxane having high solvent resistance as component (A), R¹ is methyl, phenyl or a mixture thereof in combination with 3,3,3-trifluoropropyl.

R² stands for an alkenyl group, typically of 2 to 8 carbon atoms. Examples include vinyl, allyl, 1-propenyl, isopropenyl, 1-butenyl, isobutenyl, and hexenyl. Of these, vinyl is most preferred because those organopolysiloxanes of formula (1) wherein R² is vinyl are easy to synthesize and chemically stable.

Examples of the organopolysiloxane (A) include trimethylsiloxy end-capped dimethylsiloxane-methylvinylsiloxane copolymers, trimethylsiloxy end-capped methylvinylpolysiloxane, trimethylsiloxy end-capped dimethylsiloxane-methylvinylsiloxane-methylphenylsiloxane copolymers, trimethylsiloxy end-capped dimethylsiloxane-methylvinylsiloxane-diphenylsiloxane copolymers, dimethylvinylsiloxy end-capped dimethylpolysiloxane, dimethylvinylsiloxy end-capped methylvinylpolysiloxane, dimethylvinylsiloxy end-capped dimethylsiloxane-methylvinylsiloxane copolymers, dimethylvinylsiloxy end-capped dimethylsiloxane-methylvinylsiloxane-methylphenylsiloxane copolymers, dimethylvinylsiloxy end-capped dimethylsiloxane-methylvinylsiloxane-diphenylsiloxane copolymers, divinylmethylsiloxy end-capped dimethylpolysiloxane, and trivinylsiloxy end-capped dimethylpolysiloxane. These organopolysiloxanes may be used alone or in a mixture of two or more, or a mixture of siloxanes having different degrees of polymerization.

Throughout the specification, the term “end-capped” used in connection with siloxanes means that a siloxane is capped with a specified group at each end of its molecular chain.

### Component B

Component (B) is a curing agent in the inventive adhesive which is effective for curing component (A). It is an organohydrogenpolysiloxane containing, on average, at least two, preferably at least three silicon-bonded hydrogen atoms (SiH groups) in a molecule and having a viscosity of 0.001 to 100 Pa-s, preferably 0.001 to 10 Pa-s at 23° C.

The organohydrogenpolysiloxane (B) reacts with component (A) and serves as a crosslinking agent. The molecular structure of the organohydrogenpolysiloxane is not particularly limited. It may be any of organohydrogenpolysiloxanes prepared to a linear, branched, cyclic or three-dimensional network (resinous) structure in a conventional way. The organohydrogenpolysiloxane (B) should contain at least two, preferably at least three silicon atom-bonded hydrogen atoms (i.e., hydrosilyl or SiH groups) on the molecule. Specifically, it contains preferably 2 to about 500, more preferably 3 to about 200, most preferably 3 to about 100 SiH groups.

Typical of the organohydrogenpolysiloxane are those having the average compositional formula (2).

R³_{b}H_{c}SiO_{(4-b-c)/2} (2)

Herein R³ is each independently a substituted or unsubstituted monovalent hydrocarbon group free of aliphatic unsaturation, bonded to a silicon atom; b is a positive number of 0.7 to 2.1, c is a positive number of 0.001 to 1.0, and b+c is from 0.8 to 3.0, and preferably b is 1.0 to 2.0, c is 0.01 to 1.0 and b+c is 1.5 to 2.5.

In formula (2), the substituted or unsubstituted monovalent hydrocarbon groups free of aliphatic unsaturation represented by R³ are preferably those of 1 to 10 carbon atoms, for example, alkyl groups such as methyl, ethyl, propyl, isopropyl, butyl, isobutyl, tert-butyl, pentyl, neopentyl, hexyl, cyclohexyl, octyl, nonyl and decyl, aryl groups such as phenyl, tolyl, xylyl and naphthyl, aralkyl groups such as benzyl, phenylethyl and phenylpropyl, and substituted forms of the foregoing groups in which some or all hydrogen atoms are substituted by halogen atoms (e.g., fluoro, bromo, chloro), such as chloromethyl, chloropropyl, bromoethyl and trifluoropropyl. Of these, alkyl and aryl groups are preferred, with methyl and phenyl being most preferred.

Two or more, preferably three or more SiH groups per molecule may be located at ends or intermediate positions of the molecular chain or both. The molecular structure of the organohydrogenpolysiloxane may be a linear, branched, cyclic or three-dimensional network structure. The number of silicon atoms per molecule (or degree of polymerization) is preferably 2 to about 1,000, more preferably 3 to about 300, and even more preferably 4 to about 150.

Examples of the organohydrogenpolysiloxane (B) include 1,1,3,3-tetramethyldisiloxane, 1,3,5,7-tetramethylcyclotetrasiloxane, tris(hydrogendimethylsiloxy)methylsilane, tris(hydrogendimethylsiloxy)phenylsilane, methylhydrogencyclopolysiloxane, methylhydrogensiloxane-dimethylsiloxane cyclic copolymers, trimethylsiloxy end-capped methylhydrogenpolysiloxane, trimethylsiloxy end-capped dimethylsiloxane-methylhydrogensiloxane copolymers, dimethylhydrogensiloxy end-capped dimethylpolysiloxane, dimethylhydrogensiloxy end-capped dimethylsiloxane-methylhydrogensiloxane copolymers, trimethylsiloxy end-capped methylhydrogensiloxane-diphenylsiloxane copolymers, trimethylsiloxy end-capped methylhydrogensiloxane-diphenylsiloxane-dimethylsiloxane copolymers, trimethylsiloxy end-capped methylhydrogensiloxane-methylphenylsiloxane-dimethylsiloxane copolymers, dimethylhydrogensiloxy end-capped methylhydrogensiloxane-dimethylsiloxane-diphenylsiloxane copolymers, dimethylhydrogensiloxy end-capped methylhydrogensiloxane-dimethylsiloxane-methylphenylsiloxane copolymers, copolymers consisting of (CH₃)₂HSiO_{1/2} units, (CH₃)₃SiO_{1/2} units and SiO_{4/2} units, copolymers consisting of (CH₃)₂HSiO_{1/2} units and SiO_{4/2} units, copolymers consisting of (CH₃)₂HSiO_{1/2} units, SiO_{4/2} units and (C₆H₅)₃SiO_{1/2} units, and substituted forms of the foregoing organohydrogenpolysiloxanes in which some or all methyl groups are substituted by other alkyl groups (e.g., ethyl or propyl), aryl groups (e.g., phenyl or tolyl), or haloalkyl groups (e.g., 3,3,3-trifluoropropyl), and mixtures of two or more of the foregoing organohydrogenpolysiloxanes. Inter alia, a mixture of an organohydrogenpolysiloxane having silicon-bonded hydrogen atoms only at both ends of the molecular chain and an organohydrogenpolysiloxane having silicon-bonded hydrogen atoms on side chains from the molecular chain (for example, a combination of diorganohydrogensiloxy end-capped diorganopolysiloxane with triorganosiloxy capped organohydrogenpolysiloxane, triorganosiloxy capped diorganosiloxane-organohydrogensiloxane copolymer, diorganohydrogensiloxy capped organohydrogenpolysiloxane and/or diorganohydrogensiloxy capped diorganosiloxane-organohydrogensiloxane copolymer) is preferred because the resulting cured product is improved in mechanical properties, especially elongation.

In the adhesive, component (B) is used in such an amount that the molar ratio of silicon-bonded hydrogen atoms in component (B) to alkenyl groups in component (A) is from 0.01/1 to 20/1, preferably from 0.05 to 15, more preferably from 0.1 to 10, and even more preferably from 0.5 to 5.

### Component C

Component (C) is a calcium carbonate powder surface treated with a paraffinic compound. It is a component effective for improving the adhesion of the inventive adhesive to silicone rubber. It should have a specific surface area of up to 6 m²/g, preferably up to 5 m²/g, more preferably up to 4 m²/g, as measured by the air-permeability method. The lower limit is not particularly limited, but usually at least 0.1 m²/g. Examples of the calcium carbonate powder include heavy or dry ground calcium carbonate powders, and light or precipitated calcium carbonate powders, with the heavy calcium carbonate powders being preferred.

In the inventive adhesive, the amount of component (C) is 1 to 100 parts, preferably 2 to 50 parts by weight per 100 parts by weight of component (A). Less than 1 pbw is ineffective for improving the adhesion of the inventive adhesive to silicone rubber whereas more than 100 pbw makes it difficult to prepare a uniform adhesive composition.

Unlike non-treated heavy calcium carbonate powder and heavy calcium carbonate powder surface treated with treating agents other than the paraffinic compounds, such as fatty acids and resin acids, the calcium carbonate powder, especially heavy calcium carbonate powder surface treated with a paraffinic compound do not act as a poison to platinum group catalysts or interfere with the curing of the inventive composition, so that the inventive composition remains shelf stable.

Typical paraffinic compounds used for surface treatment have the molecular formula: CH₃—(CH₂)ₙ—CH₃ wherein n is a positive number of 16 to 40, preferably 20 to 30 and include paraffin wax and polyethylene wax. The paraffinic compound may be used usually in an amount of 0.1 to 10 parts, preferably 0.5 to 5 parts by weight per 100 parts by weight of the calcium carbonate powder.

As component (C), the calcium carbonate powder previously surface treated with a paraffinic compound may be used. Alternatively, in the course of preparing the inventive composition and prior to the addition of the platinum group metal catalyst (D), calcium carbonate and a paraffinic compound may be fed along with components (A) and (B) and heat mixed at about 150 to 200° C., thereby achieving surface treatment. In the latter embodiment wherein surface treatment occurs in the course of preparing the inventive composition, the surface treatment must be completed prior to the addition of the platinum group metal catalyst (D).

Component (C) is commercially available, for example, under the trade name of MC Coat Series from Maruo Calcium Co., Ltd., for example, MC Coat P-20 which is heavy calcium carbonate surface treated with a paraffinic compound.

### Component D

Component (D) is a platinum group metal catalyst which may be any known hydrosilylation catalyst. A single catalyst or a mixture of two or more catalysts may be used. Exemplary catalysts include platinum group metals such as platinum (inclusive of platinum black), rhodium and palladium; platinum chloride, chloroplatinic acid, and chloroplatinic acid salts, such as H₂PtCl₄.nH₂O, H₂PtCl₆.nH₂O, NaHPtCl₆.nH₂O, KHPtCl₆.nH₂O, Na₂PtCl₆.nH₂O, K₂PtCl₄.nH₂O, PtCl₄.nH₂O, PtCl₂, and Na₂HPtCl₄.nH₂O wherein n is an integer of 0 to 6, preferably 0 or 6; alcohol-modified chloroplatinic acid (see U.S. Pat. No. 3,220,972); complexes of chloroplatinic acid with olefins (see U.S. Pat. No. 3,159,601, U.S. Pat. No. 3,159,662 and U.S. Pat. No. 3,775,452); platinum group metals (e.g., platinum black or palladium) on supports such as alumina, silica and carbon; complexes of platinum with triphenylphosphine; rhodium-olefin complexes; chlorotris(triphenylphosphine)rhodium (Wilkinson catalyst); and complexes of platinum chloride, chloroplatinic acid or chloroplatinic acid salts with vinyl-containing siloxanes, especially vinyl-containing cyclic siloxanes. Of these, preference is given to platinum base catalysts, such as platinum black, chloroplatinic acid, chloroplatinic acid-olefin complexes, complexes of platinum chloride, chloroplatinic acid or chloroplatinic acid salts with vinyl-containing siloxanes, especially vinyl-containing cyclic siloxanes, and complexes of platinum with triphenylphosphine.

The amount of component (D) used may be a catalytic amount for hydrosilylation reaction, and is not particularly limited as long as the desired cure rate is achieved. For example, component (D) is used in such an amount that 0.1 to 1,000 ppm, preferably 0.1 to 500 ppm, more preferably 0.5 to 200 ppm of platinum group metal is available from component (D), based on the total weight of the adhesive exclusive of component (D).

### Component E

The adhesive may further comprise (E) a finely divided silica having a specific surface area of at least 50 m²/g, specifically 50 to 400 m²/g, preferably 100 to 350 m²/g. The specific surface area as used herein is measured by the nitrogen adsorption method, especially BET method. Component (E) is effective for imparting strength to the adhesive. Component (E) used may be a single species or a mixture of two or more species.

As component (E), any of well-known finely divided silicas may be used. Component (E) may also be either hydrophilic or hydrophobic. Examples of hydrophilic finely divided silica include wet silicas such as precipitated silica, and dry silicas such as silica xerogel and fumed silica. Examples of hydrophobic finely divided silica include those obtained by hydrophobizing surfaces of hydrophilic finely divided silicas. Suitable hydrophobizing agents include organosilazanes such as hexamethyldisilazane; halogenated silanes such as methyltrichlorosilane, dimethyldichlorosilane and trimethylchlorosilane; and organoalkoxysilanes corresponding to the halogenated silanes in which halogen atoms are substituted by alkoxy groups such as methoxy and ethoxy. One exemplary hydrophobizing treatment is by heat treatment of hydrophilic finely divided silica with a hydrophobizing agent at 150-200° C., especially 150-180° C. for about 2-4 hours. The hydrophobic silica obtained by previously hydrophobizing surfaces of hydrophilic silica in this way may be incorporated in the inventive adhesive. Alternatively, in the course of preparing the inventive adhesive, hydrophilic silica and a hydrophobizing agent may be fed whereby the hydrophilic silica is surface-hydrophobized at any suitable stage of preparation.

Component (E) is commercially available, for example, hydrophilic finely divided silicas under the trade name of Aerosil® 50, 130, 200 and 300 (Nippon Aerosil Co., Ltd.), Cabosil® MS-5 and MS-7 (Cabot Corp.), Reolosil® QS-120 and 103 (Tokuyama Corp.), and Nipsil® LP (Nippon Silica Co., Ltd.); and hydrophobic finely divided silicas under the trade name of Aerosil® R-812, R-812S, R-972 and R-974 (Degussa), Reolosil® MT-10 (Tokuyama Corp.), and Nipsil® SS series (Nippon Silica Co., Ltd.).

Component (E) is optional. The amount of component (E) compounded is usually up to 100 parts (0 to 100 parts), preferably 1 to 100 parts, more preferably 2 to 50 parts by weight per 100 parts by weight of component (A). Too less amounts of component (E) may be insufficient to achieve the strength-imparting effect whereas the adhesive filled with more than 100 pbw of component (E) may become less flowable and difficult to work.

To the adhesive of the invention, other optional components may be added. For example, inorganic fillers may be added, such as fumed titanium oxide, carbon black, diatomaceous earth, iron oxide, aluminum oxide, aluminosilicate, zinc oxide, aluminum hydroxide, silver and nickel, and the foregoing fillers which have been surface treated with the organosilicon compounds described above.

Also, a tackifier may be added for enhancing the adhesion of the adhesive. Suitable tackifiers include silane coupling agents such as methyltrimethoxysilane, vinyltrimethoxysilane, allyltrimethoxysilane, 3-methacryloxypropyltrimethoxysilane, 3-glycidoxypropyltrimethoxysilane, 3-aminopropyltrimethoxysilane, N-(2-aminoethyl)-3-aminopropyltrimethoxysilane, bis(trimethoxysilyl)propane, and bis(trimethoxysilyl)hexane; organotitanium compounds such as tetraethyl titanate, tetrapropyl titanate, tetrabutyl titanate, tetra(2-ethylhexyl) titanate, titanium ethylacetonate, and titanium acetylacetonate; organoaluminum compounds such as aluminum tris(ethyl acetoacetate); alkyl acetoacetate aluminum diisopropylate such as ethyl acetoacetate aluminum diisopropylate, aluminum tris(acetylacetonate), and aluminum monoacetylacetonate bis(ethyl acetoacetate); and organozirconium compounds such as zirconium acetylacetonate, zirconium butoxyacetylacetonate, zirconium bisacetylacetonate, and zirconium ethyl acetoacetate. The amount of the tackifier added is not particularly limited although it is usually up to about 20 parts (0 to 20 parts), preferably 0.01 to 10 parts by weight per 100 parts by weight of component (A).

In the adhesive of the invention, a cure inhibitor may also be compounded for improving the shelf stability or handling efficiency thereof. Examples include acetylene compounds such as 3-methyl-1-butyn-3-ol, 3,5-dimethyl-1-hexyn-3-ol, and 3-phenyl-1-butyn-3-ol; ene-yne compounds such as 3-methyl-3-penten-1-yne and 3,5-dimethyl-3-hexen-1-yne; organosiloxane compounds containing at least 5% by weight of vinyl groups in the molecule, such as 1,3-divinyl-1,1,3,3-tetramethyldisiloxane, 1,3-divinyl-1,1,3,3-tetraphenyldisiloxane, 1,3,5,7-tetramethyl-1,3,5,7-tetravinylcyclotetrasiloxane, 1,3,5,7-tetramethyl-1,3,5,7-tetrahexenylcyclotetrasiloxane, silanol end-capped methylvinylsiloxane, and silanol end-capped methylvinylsiloxane-dimethylsiloxane copolymers; triazoles such as benzotriazole, phosphines, mercaptans, and hydrazines. The amount of the cure inhibitor added is not particularly limited although it is usually 0.001 to 5 parts, preferably 0.01 to 5 parts by weight per 100 parts by weight of component (A).

The adhesive of the invention may be prepared by any desired method. Typically, it is prepared by mixing together components (A) to (D) and optional components. Where the adhesive contains silica or component (E), the preferred procedure is by previously heat mixing components (A) and (E) to form a base compound and adding components (B) to (D) to the base compound. Where other optional components are to be added, they may be added in the step of forming the base compound. If optional components can be altered by heat mixing, they are preferably added in the step of adding components (B) to (D). In the step of forming the base compound, an organosilicon compound as mentioned above may be added whereupon surface treatment of component (E) takes place in situ. In preparing the adhesive, any well-known kneading machine such as a two-roll mill, kneader-mixer or Ross mixer may be used.

Like ordinary curable silicone rubber compositions, the adhesive of the invention may be of two-part type wherein the composition is divided into two parts, which on use are combined together for curing.

The inventive adhesive may be cured under the same conditions as are well-known addition cure type silicone rubber compositions. For example, the adhesive cures at room temperature to provide a sufficient bond to silicone rubber, although it may be heat cured at about 40 to 180° C., if necessary.

The inventive adhesive is used in bonding of silicone rubber. The silicone rubber to which the inventive adhesive is applicable is not particularly limited. The inventive adhesive is effective to addition cured silicone rubbers obtained by curing addition reaction cure type silicone rubber compositions because a better bond thereto is established. The addition reaction cure type silicone rubber compositions include well-known addition reaction cure type silicone rubber compositions comprising an alkenyl group-containing organopolysiloxane, an organohydrogenpolysiloxane, and an addition reaction catalyst.

Since the inventive adhesive is fully adherent to silicone rubbers as mentioned above, it is used in joining together silicone rubber parts, a silicone rubber part and a silicone rubber-coated part, or silicone rubber-coated parts. The silicone rubber-coated parts comprise substrates coated with silicone rubber. The substrates are preferably airbag-forming base fabrics of synthetic fibers such as polyamide (e.g., nylon 6, nylon 66, nylon 46), aramid, polyester, vinylon, rayon, polyolefin, and polyether imide textiles, but not limited thereto.

The joining method which can be employed herein is by applying the inventive adhesive to a silicone rubber and/or silicone rubber-coated part to a thickness of 0.1 to 5 mm, especially 0.2 to 2 mm, placing another silicone rubber and/or silicone rubber-coated part thereon, and allowing or causing the adhesive to cure at room temperature (23±10° C.) or elevated temperature.

### EXAMPLE

Examples and Comparative Examples are given below for illustrating the present invention although the invention is not limited thereto. All parts are by weight. The viscosity is measured by a rotational viscometer at 23° C.

### Example 1

A base compound was prepared by mixing (A) 100 parts of a dimethylvinylsiloxy end-capped dimethylpolysiloxane having a viscosity of 30 Pa-s, (E) 15 parts of fumed silica having a specific surface area of 300 m²/g as measured by the nitrogen gas adsorption method (BET), 1.5 parts of hexamethyldisilazane as a hydrophobizing agent for silica surface, and 1 part of water until uniform, and heat mixing at a reduced pressure and 160° C. for 4 hours.

An adhesive for silicone rubber was prepared by combining 115 parts of the base compound with the following components:
(C) 7 parts of heavy calcium carbonate powder surface treated with a paraffinic compound and having a specific surface area of 2.0 m²/g as measured by the air-permeability method (MC Coat P-20 by Maruo Calcium Co., Ltd.),
(B-1) a dimethylhydrogensiloxy end-capped dimethylpolysiloxane having a viscosity of 0.01 Pa-s in such an amount that a molar ratio of silicon atom-bonded hydrogen atoms (SiH groups) in component (B-1) to silicon atom-bonded vinyl groups in component (A) was 1.2,
(B-2) an organohydrogenpolysiloxane of (Me₂HSiO)₃SiMe containing three silicon atom-bonded hydrogen atoms and having a viscosity of 0.0012 Pa-s in such an amount that a molar ratio of SiH groups in component (B-2) to vinyl groups in component (A) was 0.3,
(F) 0.2 part of a silanol end-capped dimethylsiloxane-methylvinylsiloxane copolymer having a viscosity of 40 mPa-s (vinyl content=8 wt %) as a cure inhibitor, and
(D) a platinum 1,3-divinyltetramethyldisiloxane complex in such an amount that 25 parts by weight of platinum metal was available per million parts by weight of the dimethylpolysiloxane (A).

### [Tests]

Hardness

The adhesive was held at 23° C. for one day (24 hr) whereupon it cured. The cured adhesive was measured for hardness by a type A durometer according to JIS K6253. The results are shown in Table 1.

Elongation and Tensile Strength

The adhesive was held at 23° C. for one day (24 hr) whereupon it cured into a No. 3 dumbbell specimen according to JIS K6251. The specimen was measured for elongation and tensile strength by the method of JIS K6251. The results are shown in Table 1.

Bond Strength and Failure Mode

The bond strength of the adhesive to an addition cured silicone rubber was measured by the method of JIS K6854. Nylon tape strips of 25 mm wide coated with a cured product of an addition reaction cure type silicone rubber composition (i.e., silicone rubber) were joined together by sandwiching a layer of the adhesive having a thickness of 0.6 mm therebetween. The assembly was held at 23° C. for one day whereupon the adhesive cured. On the assembly, a T peel test was carried out at a pull rate of 200 mm/min for determining a bond strength. The results are shown in Table 1.

After the peel test, the interfacial state between the cured adhesive and the tape was visually observed to examine the failure mode. The rating “cohesive failure” in Table 1 means that full cohesive failure occurred at the cured adhesive. The rating “interfacial peeling” in Table 1 means that partial peel of the adhesive itself was observed at the interface between the adhesive and the silicone rubber coated on the tape).

Shelf Stability

To examine shelf stability, a composition was first prepared which consisted of the same components as the above-prepared adhesive (referred to as fresh adhesive), except that only curing agents, i.e., components (B) and (D) were excluded. This composition was held at 70° C. for one week, after which it was combined with the curing components (B) and (D) to prepare an adhesive (referred to as aged adhesive). The aged adhesive was similarly cured. The cured aged adhesive was similarly measured for physical properties (hardness, elongation, tensile strength, bond strength) and observed for failure mode. It was examined whether or not the aged adhesive was retarded from curing, as compared with the fresh adhesive. Specifically, the aged adhesive was judged as cure retarded when the cure time of the aged adhesive is 1.5 times or more the cure time of the fresh adhesive. It was also examined whether or not the physical properties were affected by aging. Specifically, the aged adhesive was judged as physical properties degraded when the value of the cured aged adhesive is equal to or less than 70% of the value of the cured fresh adhesive. Further, it was examined whether or not the failure mode was affected by aging.

With respect to shelf stability, the adhesive is rated “good” when no cure retardation occurs, no physical properties are degraded, and the failure mode is not changed. It is rated “fair” when only the failure mode is changed. Otherwise, it is rated “poor.”

### Example 2

An adhesive for silicone rubber was prepared as in Example 1 except that the amount of component (C) was changed to 15 parts. This adhesive was tested as in Example 1, with the measurement results shown in Table 1.

### Example 3

An adhesive for silicone rubber was prepared as in Example 1 except that 115 parts of the base compound in Example 1 was mixed with (C) 7 parts of untreated heavy (dry ground) calcium carbonate powder having a specific surface area of 2.0 m²/g as measured by the air-permeability method (Super #2000 by Maruo Calcium Co., Ltd.) and 1 part of a paraffinic compound having a melting point of 42-44° C. and heat treated at 160° C. for 4 hours, before the remaining components were compounded. This adhesive was tested as in Example 1, with the measurement results shown in Table 1.

### Comparative Example 1

An adhesive for silicone rubber was prepared as in Example 1 except that component (C) was omitted. This adhesive was tested as in Example 1, with the measurement results shown in Table 1.

### Comparative Example 2

An adhesive for silicone rubber was prepared as in Example 1 except that component (C) was changed to a precipitated calcium carbonate powder surface treated with fatty acid and having a specific surface area of 5.3 m²/g as measured by the air-permeability method (Hakuenka CCR by Shiraishi Kogyo Co., Ltd.). This adhesive was tested as in Example 1, with the measurement results shown in Table 1.

### Comparative Example 3

An adhesive for silicone rubber was prepared as in Example 1 except that component (C) was changed to a precipitated calcium carbonate powder surface treated with resin acid and having a specific surface area of 5.3 m²/g as measured by the air-permeability method (MT-100 by Maruo Calcium Co., Ltd.). This adhesive was tested as in Example 1, with the measurement results shown in Table 1.

### Comparative Example 4

An adhesive for silicone rubber was prepared as in Example 1 except that component (C) was changed to an untreated heavy (dry ground) calcium carbonate powder having a specific surface area of 2.0 m²/g as measured by the air-permeability method (Super #2000 by Maruo Calcium Co., Ltd.). This adhesive was tested as in Example 1, with the measurement results shown in Table 1.

TABLE 1

| | | Example | | | Comparative Example | | | |
|---|---|---|---|---|---|---|---|---|
| | | 1 | 2 | 3 | 1 | 2 | 3 | 4 |
| Hardness | | 7 | 12 | 7 | 5 | 9 | 10 | 7 |
| Elongation (%) | | 1980 | 1690 | 1950 | 1960 | 1890 | 1740 | 1910 |
| Tensile strength | | 3.6 | 4.5 | 3.5 | 2.5 | 3.9 | 4.3 | 3.4 |
| (MPa) | | | | | | | | |
| Bond strength | | 4.5 | 4.1 | 4.4 | 5.0 | 4.8 | 5.1 | 4.6 |
| (kgf/25 mm) | | | | | | | | |
| Failure mode | | cohesive | cohesive | cohesive | interfacial | cohesive | cohesive | cohesive |
| | | failure | failure | failure | failure | failure | failure | failure |
| Shelf | Cure | no | no | no | no | retarded | retarded | no |
| stability | retardation | | | | | | | |
| | Physical properties | no | no | no | no | degraded | degraded | no |
| | degradation | | | | | | | |
| | Failure mode | no | no | no | no | changed | changed | changed |
| | change | | | | | | | |
| | Rating | good | good | good | good | poor | poor | fair |

Japanese Patent Application No. 2006-101551 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An adhesive for silicone rubber comprising
(A) 100 parts by weight of an organopolysiloxane containing, on average, at least two silicon-bonded alkenyl groups in a molecule and having a viscosity of 0.05 to 1,000 Pa-s at 23° C.,
(B) an organohydrogenpolysiloxane containing, on average, at least two silicon-bonded hydrogen atoms in a molecule and having a viscosity of 0.001 to 100 Pa-s at 23° C., in such an amount that the molar ratio of silicon-bonded hydrogen atoms in component (B) to alkenyl groups in component (A) is from 0.01 to 20,
(C) 1 to 100 parts by weight of a calcium carbonate powder surface treated with a paraffinic compound and having a specific surface area of up to 6 m²/g, as measured by the air-permeability method, and
(D) an effective amount of a platinum group metal catalyst.

2. The adhesive of claim 1, wherein the calcium carbonate powder (C) is a heavy calcium carbonate powder having a specific surface area of up to 6 m²/g, as measured by the air-permeability method.

3. The adhesive of claim 1, further comprising
(E) 1 to 100 parts by weight of a finely divided silica having a specific surface area of at least 50 m²/g, as measured by the nitrogen adsorption method.

4. The adhesive of claim 3, wherein components (A) and (E) are previously heat mixed.

5. The adhesive of claim 1, further comprising a tackifier.

6. The adhesive of claim 1, for use with a silicone rubber obtained by curing an addition cure type silicone rubber composition.
